(19) United States
(12) Patent Application Publication
(10) Pub. No.: US 2004/0243519 A1
(43) Pub. Date: Dec. 2, 2004

(54) Prompted electronic mobile-service information communications with validation

(75) Inventors: Marko Perttila, Pernaja (FI); Marko Vanska, Espoo (FI)

Correspondence Address: Crawford Maunu PLLC, Suite 390, 1270 Northland Drive, St. Paul, MN, 55120, US

(73) Assignee: Nokia Corporation

(21) Appl. No.: 10/452,865

(22) Filed: Jun. 2, 2003

(51) Int. Cl. G06F 17/60

(52) U.S. Cl. 705/75

(57) ABSTRACT

An electronic service information data (including, e.g., an electronic coupon) is sent to a user in response to interaction at a merchant-media arrangement. According to one example embodiment, a user with a user-communications device views information conveyed by the merchant-media arrangement. In response to communication between the user-communications device and the merchant-media arrangement, the user-communications device and the merchant-media arrangement cooperate to generate a merchant-information-request signal that includes at least a merchant-media ID code for the merchant-media arrangement. The merchant-information-request signal is then used to generate a user-redeemable electronic service information that corresponds to the information conveyed by the merchant-media arrangement (e.g., via the merchant-media ID code). In a more specific embodiment, the electronic service information is sent in a Java Midlet that is downloaded for access and activation by the user. With this approach, users can conveniently request and/or receive electronic service information at a point-of-use media display.

### FIELD OF THE INVENTION

This invention relates in general to communications, and more particularly to a system, method and apparatus for processing electronic commerce involving radio communication technology.

A portion of the disclosure of this patent document contains material which is subject to copyright protection. The copyright owner has no objection to the facsimile reproduction by anyone of the patent document or the patent disclosure, as it appears in the U.S. Patent & Trademark Office patent file or records, but otherwise reserves all copyright rights whatsoever.

### BACKGROUND OF THE INVENTION

Traditional approaches to data communication in public places, such as advertising or providing other information in public places, have relied upon relatively simple approaches, typically involving printed and/or displayed media. This displayed media approach is relatively devoid of interactive communications. Billboards, kiosks, vending machines, restaurant menus and other forms of public advertising do not provide real-time feedback to consumers. For instance, when a consumer wishes to obtain data or learn more about a particular advertisement, he or she must typically either remember or write down information, and at a later time seek out any additional information he or she is interested in learning about.

In some instances, such public data communications have involved wireless technologies that have improved the ability of consumers to communicate in public places. For example, wireless Internet appliances enable users to access the Internet and retrieve advertising information from a public place where wireless communications are present. Various wireless devices, such as cellular telephones and personal digital assistants (PDAs) have been used in these applications.

More recently, these communications technologies have been involved in advertising approaches that use electronic coupons (“e-coupons”). Such coupon advertising includes transferring typically coupon information, such as a coupon ID (identification) ad/or other information related (or leading up) to a merchant offering, to a first portable terminal where the coupon information is stored. The portable terminal displays a representation of the transferred coupon information on a display thereof. The stored coupon information may be transferred for redemption or other purposes. Another coupon advertising approach sends e-coupons to consumer terminals, such as cellular phones. The cellular-phone user finds an e-coupon issue center by reading the phone's ID with an opto-electrical transducer or by keying in the ID information. After verifying the ID, the e-coupon issue center issues and transmits the e-coupon ID to the consumer terminal. The consumer uses the e-coupon ID and his own ID at a retailer which accesses the issue center to determine the validity of the e-coupon; such coupon redemption can occur electronically or manually.

While these approaches have been found useful in conveying advertising information (including coupons) to users in public locations, the manner in which they process such advertising information is relatively burdensome. For example, in certain applications, these approaches require relatively complex coupon validation and redemption processing. Also, where a coupon has special restrictions, such as one-time, date and/or location limitations, verifying the validity of the coupon has been difficult.

In view of the above, there is a need for interactive information exchange that is convenient and inexpensive.

### SUMMARY OF THE INVENTION

The present invention is directed to a system, apparatus, and method for sending service data in response to electronic communications between a user communications device and a merchant-media arrangement (e.g., audio and/or visual advertisements).

According to an example embodiment of the present invention, an interactive communications system conveys service information to a user-communications device by way of a merchant-media arrangement. The merchant-media arrangement has a merchant-media ID code and is adapted to communicate service initiation information, including the merchant-media ID code, to requesting devices over a short-range communication link. The user-communications device is adapted to receive the service initiation information, including at least the merchant-media ID code, and in response to receiving the service initiation information, is adapted to send a merchant-information-request signal that includes the merchant-media ID code. An electronic commerce arrangement adapted to generate, in response to receiving the merchant-information-request, a service information data set that corresponds to the merchant-media ID code. The electronic commerce arrangement is further adapted to send the application data set to an address for access by the user.

In more particular embodiments, the service information data set involves validation and/or redemption, and for such embodiments the interactive communications system also includes an electronic commerce redemption arrangement that is adapted to validate the service information data set.

According to another example embodiment, a user with a user-communications device views information conveyed by the merchant-media arrangement. In response, the user-communications device cooperates with the merchant-media arrangement to generate a merchant-information-request signal that includes at least a merchant-media ID code for the merchant-media arrangement. The merchant-information-request signal is then used to generate a user-redeemable electronic coupon that corresponds to the information conveyed by the merchant-media arrangement (via the merchant-media ID code). In certain applications, the electronic coupon is generated by and sent from a remote server in a Java Midlet that is downloaded for access and activation by the user.

In a specific implementation, the user-communications device connects to the remote server and the above-mentioned cooperation between the user-communications device and the merchant-media arrangement includes communication of the merchant-media ID code to the user-communications device which generates the merchant-information-request signal. Consistent with this specific implementation, the user-communications device may be, for example, a wireless telephone, and adapted for downloading such an electronic coupon (in a Java Midlet or other form).

In a specific implementation, the user-communications device connects to the remote server and the above-mentioned cooperation between the user-communications device and the merchant-media arrangement includes communication of the merchant-media ID code to the user-communications device which generates the merchant-information-request signal. Consistent with this specific implementation, the user-communications device may be, for example, a wireless telephone, and adapted for downloading such an electronic coupon (in a Java Midlet or other form).

In another specific implementation, the connection to the remote server is accomplished by the merchant-media arrangement, and the above-mentioned cooperation between the user-communications device and the merchant-media arrangement includes communication of the user ID code (e.g., wireless telephone number) to the merchant-media arrangement which, in turn, generates the merchant-information-request signal. Consistent with this specific implementation, the user-communications device may be, for example, a wireless telephone, an infrared transmitter, an RFID tag, or a pager. If used in this specific implementation, the electronic coupon can be downloaded or sent to a designated device or address specified in connection with the merchant-information-request signal (optionally in a Java Midlet).

In another example embodiment of the present invention, an interactive system includes a merchant-media arrangement for conveying merchant-media information to a user, a coupon-generation arrangement for generating an electronic coupon for the user, and a coupon-redemption arrangement. In response to the user-communications device picking up a short-range ID code from the merchant-media arrangement, merchant-information-request signal representative of the merchant-media ID code and the user-communications device establishes a link with a remote source server and sends the ID signal (along with the user's ID code in some implementations) to the remote source server where an electronic coupon is generated. The electronic coupon is sent to the user in the form of an electronic data set corresponding to the merchant-media's ID code. The user then redeems the electronic coupon at the coupon-redemption arrangement which is typically located at another location. The coupon-redemption arrangement then validates the electronic coupon and voids the potential for a subsequent, unauthorized redemption.

In accordance with another exemplary embodiment of the invention, a user-communications device is provided for use in an interactive communications system having merchant-communication terminals adapted to convey service information. The user-communications device, such as a mobile phone, PDA, etc., includes a first communication circuit adapted to communicate with a merchant-communication terminal over a short-range communication link. The first communication circuit is adapted to receive service initiation information including at least a merchant-media ID code assigned to the merchant-communication terminal. In response to receiving the service initiation information, the first communication circuit sends a merchant-information-request signal that includes at least said merchant-media ID code. A second communication circuit is provided, and is adapted to receive an application data set from the interactive communications system, where the application data set is sent in response to the merchant-information-request signal. A programmable processor circuit is adapted to process the application data set, and in response, provides merchant-related information for the user.

The above summary of the present invention is not intended to describe each illustrated embodiment or implementation of the present invention. The figures and the associated discussion that follows describe further embodiments and implementations.

### BRIEF DESCRIPTION OF THE DRAWINGS

Various aspects of the invention are described in connection with the example embodiments illustrated in the figures, in which:

FIG. 1a is a system for the communication of an electronic coupon to a user via a link established with a source server by a mobile communications device, according to an example embodiment of the present invention;

FIG. 1b is a flow chart showing an example manner in which the system of FIG. 1a may be implemented, according to another aspect of the present invention;

FIG. 2 is a system for the communication of an electronic coupon to a user via a link established with a source server by a merchant media arrangement, according to another example embodiment of the present invention; and

FIG. 3 is a portable media communications arrangement for implementation in connection with merchant-media, according to another example embodiment of the present invention; and

FIG. 4 is a mobile communications device for implementation in connection with the example system shown in FIG. 1a, according to another example embodiment of the present invention.

### DETAILED DESCRIPTION OF THE INVENTION

In the following description, reference is made to the accompanying drawings that form a part hereof, and in which is shown by way of illustration the example embodiments in which the invention may be practiced. It is to be understood that other embodiments may be utilized, as structural and operational changes may be made without departing from the scope of the present invention.

Generally, the present invention is directed to use of local communication technology, to initiate electronic commerce, such as retrieval of coupon-based information from a remote source server where the coupon-based information may or may not involve a pricing information for a particular manufacturer, product, service, event, etc. In typical applications of the present invention, this retrieval involves wireless and/or wired networks such as the Internet and various mobile-telephone networks. The local communication can be implemented in various forms, such as using short-range RF communication technologies, to provide interaction between a user's mobile communications device (e.g., mobile telephone or PDA) and a communication-enhanced merchant-media arrangement that is adapted to convey necessary information for allowing the mobile communications device to request electronic commerce applications from the remote server.

According to one embodiment of the present invention, with a mobile communications device in hand, the user approaches a merchant-media arrangement including a billboard or any other information providing source, which is directed to provide some general information of available services offered by the merchant-media arrangement. In one exemplary implementation, the information providing source may be a poster in an entrance of a shopping mall stating “Check here for latest offerings”. In alternative embodiments the merchant-media arrangement may not include any information providing source. The merchant-media arrangement includes also a short-range communicator for transmitting service-related information to requesting mobile communications devices. The transmitted information allows the mobile communications device to initiate an electronic commerce application, for example by sending a request over cellular network to a remote server for receiving electronic coupon information including various offerings. The billboard may be promoting a particular concert or other event (e.g., sale or performance), or may alternatively be constant. In another application, the billboard may be promoting a food product, and the request to the remote server corresponds to a request for receiving electronic coupon information including, for example, a restaurant menu or a recipe involving that particular food or food type.

The link to the remote source server is obtainable by visiting this particular billboard location. The short-range communicator transmits a merchant-media identification (ID) code and other necessary information to the mobile communications device. The mobile communications device, in turn, establishes a link with the remote processing arrangement to provide the user with electronic commerce application, such as, a downloadable electronic coupon that corresponds to the content promoted by the billboard.

The merchant-media ID code is used to associate the promotional information with an e-coupon to be provided to the user visiting this billboard location, which may be stationary or mobile (such as an advertising banner in a train or bus). In this manner, the promotion information is linked to this particular location, and the user visits and views the promotional information in order to receive the coupon offering. This electronic coupon can then be brought to a specific location where the coupon is validated to facilitate merchant transactions, e.g., discounts for the promoted merchant offerings.

The link for communicating with the remote processing arrangement (or server) can be transmitted to the mobile communications device automatically along with the merchant/billboard ID code for convenient link-connection facilitation. The user can then establish the connection to the link with entry of 1-2 key strokes which thereby select the full address for this connection. As an alternative to the above automatic/semi-automatic server connection, the link information for connecting to the server can be visually or audibly displayed for the user who can then subsequently key-in the data for connecting to the link. In this regard, the data transmitted from the merchant media arrangement to the mobile communications device includes both the remote-server link for connecting to the server and the merchant ID code which permits the server to identify the coupon type to send back to the user. The remote server can also use the merchant ID code to determine the location of the merchant media arrangement; this determination is advantageous for coupons having location-dependent price and/or expiration periods restrictions.

In one particular example embodiment, a merchant-media arrangement is equipped with an electromagnetic and/or electrostatic coupling device for use in the radio frequency (RF) portion of the electromagnetic spectrum, using radio frequency identification (RFID). The user's mobile communications device is equipped with an RFID reader adapted to emit RF activation waves, and transponders or “tags” brought within the range of the RFID reader are activated by the RF activation. When activated, the tags transmit information to the RFID reader. For instance, when the tag is within sufficient range of the RFID reader to enable communications therebetween, the merchant ID code is transmitted by the merchant-media arrangement, optionally along with the server link information, from the tag to the RFID reader. The user's mobile communications device then establishes the link to the remote server in a manner consistent with the above description. For general information regarding RFID principles, and for specific information regarding RFID approaches that may be implemented in connection with one or more example embodiments discussed herein, reference may be made to “Radio Frequency Identification—RFID: A Basic Primer,” published by the Automatic Identification Manufacturers (AIM), Oct. 23, 2001 and fully incorporated herein by reference.

In a more specific example embodiment, the mobile communications device also sends its own ID code along with the merchant ID code to the remote server. For instance, where the mobile communications device is a wireless telephone, its telephone number can act as the ID code for transmission to the remote server. In a particular cellular system, this user-terminal ID may be, for example, the phone number (MSISDN) or alternatively another ID, such as, for example the Bluetooth Address (BD_ADDR) of the mobile terminal. In one embodiment the remote server may use the ID code of the mobile communications device for user tracking purposes. In another embodiment, MSISDN and BD_ADDR data may also be used to fetch user profile information from the remote server or from another entity in order to provide more personalized offering to the user. Where the server is also adapted to store designated coupon-receipt addresses that indicate alternative locations (e.g., email addresses) for certain server-subscribing users, the remote server also uses this ID code for retrieving, and sending the electronic coupon (and/or other data per the user profile information), to this stored user address.

In yet another embodiment, the link-establishing roles of the user's mobile communications device and the merchant-media arrangement are reversed. The merchant-media arrangement is equipped with an RFID reader for emitting RF activation waves, and the mobile communications devices are equipped with transponders or “tags” so that when they are brought within the range of the RFID reader, they are activated by the RF activation. Once activated, the ID code of the user's mobile communications device is sent to the merchant-media arrangement, which already possesses the link for establishing communications with the server. The merchant-media arrangement then uplinks its own merchant ID code along with the mobile communications device ID code to the remote server. The remote server can then use both the merchant ID code and the ID code of the mobile communications device as described above.

In particular implementations, the remote server acts independent of whether the link is being established by the user's mobile communications device or the merchant-media arrangement. The remote server can generate and return an appropriate electronic commerce application, such as an electronic coupon by relying on the merchant ID code to identify the type of product conveyed by the merchant-media arrangement. Accordingly, from this perspective at the remote server node, the user's mobile communications device and the merchant-media arrangement can be considered, collectively, as being provided by an arbitrary communication node. In these implementations, the merchant-media arrangement does not need to read the ID code from the user's mobile communications device, and the remote server generates and returns an electronic coupon as a coupons data set to whichever equipment establishes the link.

In more specific embodiments, the electronic coupons (“e-coupons”) are Java Midlets that are downloadable by the user's mobile terminal in response to the communications link to the remote source server, or by the equipment that establishes the link. The remote source server is adapted to provide the electronic coupon information in this Java Midlet form. For example, the link may be a mobile network or an online WEB/WAP link, which provides the coupon information.

Depending on the particular implementation, the remote source server provides the electronic coupon information at a time and to a particular device or address, as directed by a predetermined program or data stored at the server, or according to an instruction passed to the remote source server by the equipment that establishes the link.

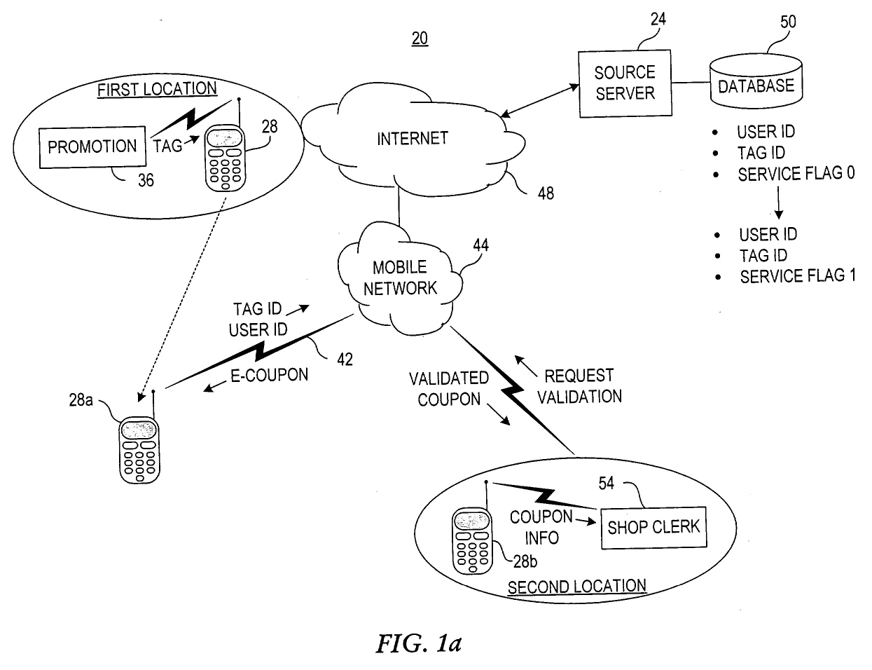

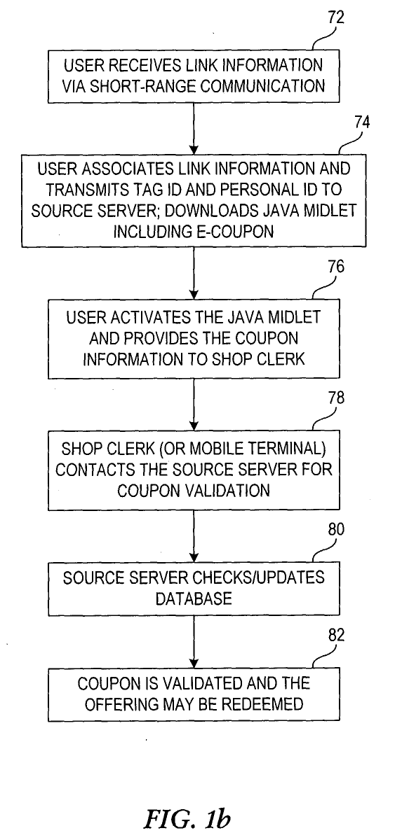

FIG. 1 illustrates a coupon-retrieval system 20 as yet another embodiment consistent with the present invention. System 20 provides an electronic coupon in response to a link is established with a source server 24 by a user 28 having a mobile communications device; in this example, the mobile communications device is a wireless telephone 28 (shown as telephone 28a while the link is being established). FIG. 1b illustrates a corresponding manner in which the system 20 may be used.

Referring to the upper left of FIG. 1a and to block 72 of FIG. 1b, a merchant promotional article 36, or merchant-media arrangement is featured by way of a poster or the like at a first location. An RFID tag 38 is co-located at the merchant-media arrangement at the first location (e.g., attached to the merchant promotional article 36), and is used to communicate a merchant ID code (and, optionally, link information for connecting to the source server 24) to associate the merchant promotional article 36 with a particular coupon to be provided to the user 28. As an alternative to using of the RFID tag 38, the merchant ID code can be communicated through an alternative short-range communication link such as a Bluetooth link or an IrDa link provided through a local short-range wireless access point or beacon device at said first location. It should be noted that using RFID tags in information delivery is preferred option because the tags can be energized by the RFID reader and therefore there is no need for any kind of power source. In any case, to receive the coupon information, the user physically visits the first location, and the mobile communications device receives the merchant ID code which is ultimately received and processed by the source server 24 for generating the electronic coupon.

After receiving the merchant ID code and the link information at the first location, the telephone 28a establishes the link 42 with the source server 24 through a mobile network 44 and/or the Internet 48 with the received link information, depicted at block 74 of FIG. 1b. When receiving the request from the terminal, the source server 24 extracts the user/terminal ID along with the tag (merchant-media) ID from the request. According to various embodiments, there is no need for a direct link, meaning that the request may be communicated by the mobile communications terminal using SMS or MMS messaging. The extracted user/terminal ID and the tag ID are stored by the source server and the source server provides the user terminal with an option to download for example a Java Midlet that corresponds to the request. This Midlet transmission can occur over the same communications link 42 or over another subsequently-established link (not shown) involving the same terminal or another terminal designated by way of the user ID and/or other instruction data provided to the source server 24. In various embodiments of the present invention, the user/terminal ID may affect the Midlet contents, so the offerings may be mobile-ized to the user if there is a database 50 with user profile information already stored and accessible to the source server 24.

After receiving the Midlet, the user terminal may store it for later activation. Such activation is depicted at block 76 of FIG. 1b. For example, as shown in connection with the telephone 28b of FIG. 1a and with block 78 of FIG. 1b, certain example types of electronic coupons (e.g., product offering with price discounts) may require validation and/or redemption. For such electronic coupons, the user's terminal visits a second location such as a merchant-purchase center where a redemption data-processing station 54 validates such coupons. At such a redemption data-processing station 54, the user may activate the Midlet or, alternatively, the Midlet may be activated automatically using some kind of location based triggering (e.g., when the user terminal detects a certain Bluetooth address or through other means). It should be noted that the second location may also be the same as the first location, for example, in cases where the coupon offerings are provided to mobile users through tag or beacons located at the store itself. This implementation could be useful and particularly advantageous in applications where the user might have many offerings and the mobile terminal is used to maintain the offerings until redemption.

The redemption can be done in several ways. In one embodiment the user can physically “show” a printed or electronically stored version of the coupon to service personnel when obtaining redemption, and the service personnel may validate the coupon by inserting a “secret” code that is used for validating the coupon. In this context, it will be appreciated that such an electronic coupon provides merchant-based service information which service personnel, acting as agents for an associated merchant, use in connection with such redemption.

In connection with the coupon being redeemed, first validation occurs. Validation may be made by the redemption data-processing station 54 communicating with the source server 24, as shown at the lower portion of FIG. 1a and at block 78 of FIG. 1b. With such a communication, a void request is transmitted to the source server 24, which marks the coupon as “used.” In particular applications where such a coupon is valid for only the user to whom it is issued and is valid for only a single use, the “void” action prevents a second use and/or use after an attempt to by unauthorized holder of the coupon. As an alternative, the coupon information may be communicated over short-range communication link through a local short-range wireless Access Point or beacon, and after receiving the coupon information, the local Access Point or beacon extracts the ID information and sends the void request to the source server when the coupon is validated at the location. In this alternative embodiment, the mobile terminal does not need to send any information through communication network when using the coupon offerings.

Upon receiving this request from the redemption data-processing station 54, the source server 24 performs coupon-verification and credit actions and updates its coupon-database accordingly. As a more specific example depicted at block 80 of FIG. 1b, the source server 24 receives the void request, and then checks the database 50 to determine whether the coupon is valid. This validity check can be performed by searching the database for a file with user ID and tag ID of the void request. If such a file is found, the source server records a service flag to indicate that the coupon is valid (flag is set to “0”). The source server then sends an acknowledgement back to the station 54 and the coupon is voided. In this manner, the coupon is validated and the offering can be redeemed (Block 82 of FIG. 1b).

If the service flag indicates that the coupon is not voidable (e.g., already used or expired), the flag is set to “1” and a non-acknowledgement is sent back to the station 54. Depending on the particular embodiment and application needs, a confirmation is typically received before providing the user with the coupon offering to ensure that the user has rights to use the coupon offering.

In some applications, the electronic coupon may be a movie ticket or like that may be purchased earlier and the coupon redemption needs to be done at a time much later than the time when the electronic coupon is received.

In other embodiments, the present invention addresses a need to provide an easy system for allowing discontinuation in usage of the electronic coupon service. In order to provide means for such a system, a “contextual bookmarking” is used with a bookmark ID tag being provided for triggering the coupon to a next “phase” in order to carry out the e-coupon offering. One example applies to the situation when a user has already paid for a movie ticket and received an e-coupon; when the user enters the cinema doorway with the paid-for movie ticket in hand, his mobile terminal is used to read the bookmark ID that triggers the c-ticket to enter next phase (i.e., ticket verification) in order to gain access to enter the movie theatre.

In a more particular embodiment, the mobile-phone is programmed (e.g., via the c-coupon Java Midlet or pre-programmed at the point of sale) to help with validation by having the mobile-phone user present the e-coupon offering by way of the mobile-phone's display and keypad. In an example application, the user employs a displayed menu to activate the c-coupon offering and thereby initiate the mobile-phone's display to read, “Show this to the cashier.” The user then presents the e-coupon by way of the mobile-phone's display to the cashier at the ticket counter. Under the text “Show this to the cashier,” the mobile-phone's display shows the date when the c-coupon offering was downloaded to the mobile phone and also the following text (for the example e-coupon ticket):

“Monday to Thursday acts”

“two tickets”

“only with single price”

“effective only after <date of premiere showing>”.

With the above data displayed, the cashier borrows the mobile phone and, using its keypad, enters a validation-test code (e.g., 5466) that is known only to the cashier. In response to receiving this validation-test code (e.g., downloaded with the e-coupon data), the mobile-phone's e-coupon programming then causes the mobile phone to check its nonvolatile memory and to display whether or not the e-coupon benefit is valid. If the mobile-phone user is authorized to use the benefit, the mobile-phone's display reads, “Coupon is valid” and the validation-test code is changed to void the possibility of another use. If, however, the benefit has already been realized (or the e-coupon is being presented by an unauthorized user), the mobile-phone's display reads, “Coupon was used previously” (or “Unauthorized user”).

Such authorized-user validation is optional and can be implemented by the remote server being implemented to send the c-coupon to the mobile phone along with a user password. With the mobile phone being further adapted to prompt the cashier, the cashier can ask the user to enter the password into the phone (e.g., using the keypad). If the user-entered password matches the memory-hidden password stored by the mobile phone, the mobile-phone responds by displaying, “Password is valid.” If the user-entered password does not match the memory-hidden password stored by the mobile phone, the mobile-phone responds by displaying, “Password is invalid”.

By providing the server both the local merchant ID (such as the cinema theatre hall doorway) and the user ID, the server can determine the right phase of the service process and provide the right support for that phase. Should there be an over-publication of coupons for a particular theatre showing at a given time, for example, the server can report that the electronic coupon is void, or offer to exchange the coupon for a discount to another merchant product (such as a theatre showing at the same theater or another time, or a discount at the concessions stand).

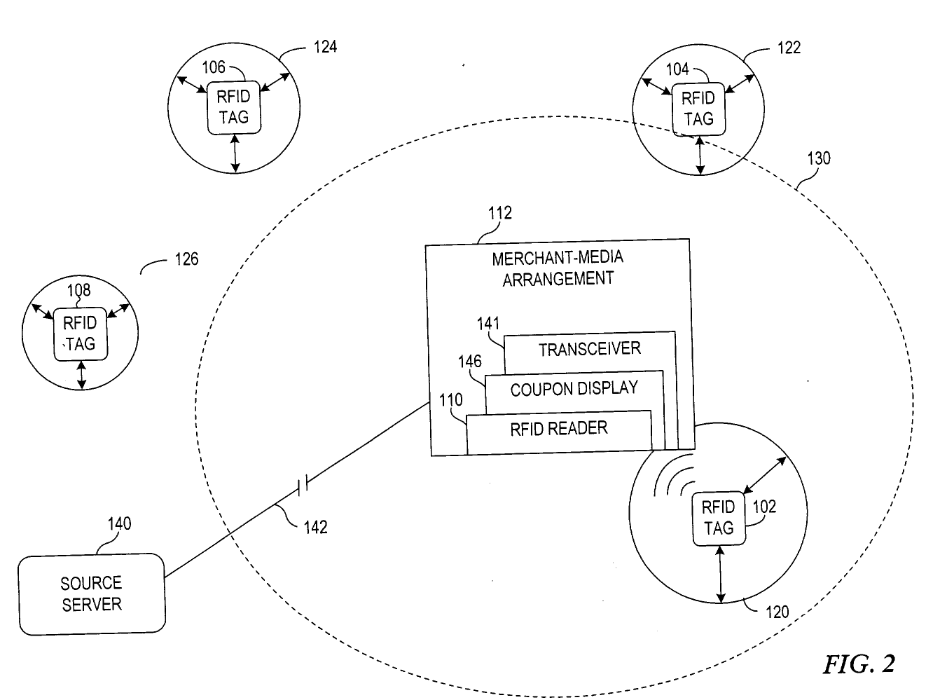

FIG. 2 is a block diagram illustrating another example embodiment of the present invention, in which a merchant-media arrangement 112 establishes the initial link with remote source server 140 rather than a mobile communications device. FIG. 2 depicts a number of such RFID tags, namely RFID tags 102, 104, 106, 108, with each RFID tag shown having a corresponding communications range. When a particular RFID tag is brought within its range of the RFID reader 110, a user ID at the RFID tag is transmitted to the RFID reader. In one implementation, the RFID tag is part of a user's mobile communications device having other regularly-used functions; for example, the RFID tag can be part of a wireless telephone or embedded in the carrying case of the telephone.

The merchant-media arrangement 112 initiates programmed tasks, such as communicating applications, services or other specific actions, in response to detecting that such an RFID tag 102 is within a certain range of the RFID reader 110, as discussed herein. The merchant-media arrangement 112 further includes a communication circuit 141 (including for example a mobile telephone transceiver) that sends data representing the RFID tag and the merchant-media ID to the remote processing arrangement 140 using a communications link 142.

The communications link 142 can be implemented in one or more of a variety of links, such as wired and/or wireless link, a mobile telephone link or an Internet link. In addition, the communications link 142 is adapted for communicating one or more types of data, such as Internet protocol data, packet data and telephony data. The communications link 142 is also used for downloading the electronic coupon data set from the source server 140.

Once downloaded, the user presenting the particular RFID tag 102 can then retrieve the coupon using any of a variety of mechanisms. In one implementation, the electronic coupon is in the form of a special promotional code, for example, including a location number and an offering number. In other implementations, the electronic coupon is displayed in the form of an electronically- or as a physically-removable article. To achieve these various types of displays, the merchant-media arrangement 112 of FIG. 2 is shown as including coupon display equipment 146 which may be a visual-display terminal, a printer, a magnetic card-code encoder, or the like.

The redemption aspects of the system, including the merchant-purchase center and redemption data-processing equipment is not shown in FIG. 2. It will be appreciated, however, that these other processing aspects operate as described in connection with FIGS. 1a and 1b.

In other example embodiments, the merchant-media arrangement shown in FIG. 2 includes user feedback, such as an LED (light-emitting diode) or a speaker emitting an audio signal, to indicate that the user's terminal ID has been read. Also, the merchant-media arrangement can include selection means (e.g., manual key-entry or voice-activated) that permits the user to select coupons for other products or for other information. In a slightly more enhanced embodiment, manual key-entry means permits the user to key-in an address (e.g., email address) for the server to mail the coupon.

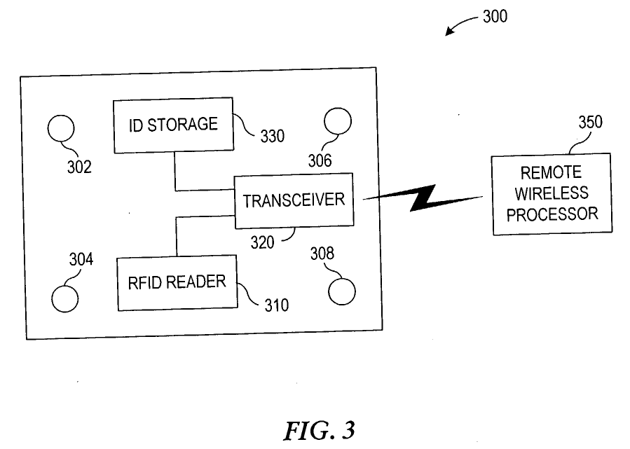

FIG. 3 shows a portable add-on media communications arrangement 300 adapted for implementation with fixed and mobile conventional advertising arrangements, such as a billboard or other advertisement arrangement on stationary display or in public transportation vehicles (e.g., busses, subways and trains). The media communications arrangement 300 is adapted for coupling with one or more of a plurality of types of media, such as advertising billboards, display screens, vending machines, advertising kiosks, ticketing machines, point-of-sale terminals and others. Optionally, fasteners 302, 304, 306 and 308 (e.g., screws and/or adhesive) are used to fasten the media communications arrangement 300 to advertising media. The media communications arrangement 300 includes an RF device 310 (a tag for an embodiment consistent with FIG. 1a or an RFID reader for an embodiment consistent with FIG. 2) and an identification (ID) storage device 330 that are coupled to a transceiver 320. The RF device 310 is adapted to send activation signals for activating RFID tags brought within a particular range of the RFID reader arrangement 300 (e.g., as discussed above). The ID storage device 330 stores a unique ID for the RFID reader arrangement 300.

In response to the RFID reader receiving tag information, the transceiver 320 sends a wireless signal to a remote wireless processor arrangement 350, the wireless signal including the unique ID for the media communications arrangement 300 and the RFID tag information. The remote wireless processor arrangement 350 is pre-programmed with media content information assigned to the unique ID for the media communications arrangement and with user preferences including user address information and one or more preferred types of communications associated with the tag. In response to receiving the wireless signal from the transceiver 320, the remote wireless processor arrangement 350 uses the unique ID to retrieve media content information associated therewith and uses the tag information to send the media content information to the user address using the preferred type of communications.

The media communications arrangement 300 is adaptable for use with existing advertising media and also can be moved or implemented with updated advertising media. For instance, when the media communications arrangement 300 is moved to a different type of advertising media, the remote wireless processor 350 is programmed to assign the unique ID to a new type of media content associated with the different advertising media.

Similarly, when the advertising media to which the media communications arrangement 300 is attached is changed, the remote wireless processor 350 is correspondingly reprogrammed to assign the unique ID to a new type of media content, consistent with the changed advertising media. For instance, when the content of a billboard is changed, the unique ID is assigned to the changed content. The content may also be audio information delivered through loudspeakers installed at the merchant media arrangement.

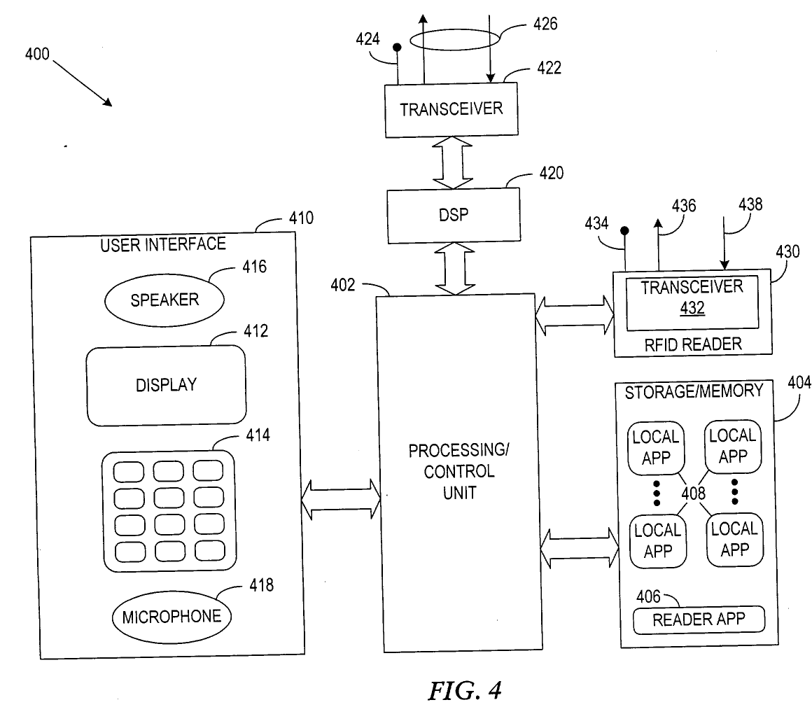

The mobile communications devices (or mobile terminals) described in connection with the present invention may be any number of wireless devices, such as wireless/cellular telephones, PDAs, or other wireless handsets, as well as portable computing devices capable of wireless communication. The mobile terminals utilize computing systems to control and manage the conventional device activity as well as the functionality provided by the present invention. Hardware, firmware, software or a combination thereof may be used to perform the various functions, display presentations and operations described herein. An example of a representative mobile terminal computing system capable of carrying out operations in accordance with the invention is illustrated in FIG. 4.

The exemplary mobile computing arrangement 400 suitable for performing the operations in accordance with the present invention includes a processing/control unit 402, such as a microprocessor, reduced instruction set computer (RISC), or other central processing module. The processing unit 402 need not be a single device, and may include one or more processors. For example, the processing unit may include a master processor and associated slave processors coupled to communicate with the master processor.

The processing unit 402 controls the basic functions of the mobile terminal as dictated by programs available in the program storage/memory. More particularly, the program storage/memory 404 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. Particular modules associated with the present invention, such as reader application 406 and local applications 408, may be invoked in response to user prompts (via user-interface 410 described below) and/or in response to wireless communications with a media arrangement. Physical browsing modules may be factory installed in the program storage/memory 404 or may be identified by application identifiers and transmitted to the mobile computing arrangement 400 via data signals, such as being downloaded electronically via the Internet or intermediary wireless networks.

The program storage/memory 404 may also be used to store data, such as the content provided by an RFID tag. In one embodiment of the invention, the content is stored in non-volatile electrically-erasable, programmable ROM (EEPROM), flash ROM, etc., so that the content is not lost upon power down of the mobile terminal.

The processor 402 is also coupled to user-interface 410 elements associated with the mobile terminal. The user-interface 410 of the mobile terminal may include, for example, a display 412 such as a liquid crystal display, a keypad 414, speaker 416, and microphone 418. These and other user-interface components are coupled to the processor 402 as is known in the art. The keypad 414 includes alpha-numeric keys for performing a variety of functions, including dialing numbers and executing operations assigned to one or more keys. For example, in accordance with the present invention, various functions associated with the network communications may be initiated and/or carried out by using the keypad 414. Alternatively, other user-interface mechanisms may be employed, such as voice commands, switches, touch pad/screen, graphical user interface using a pointing device, trackball, joystick, or any other user interface mechanism.

In accordance with another particular example implementation of the present invention, the program storage/memory 404 includes calendar-based menu data that indicates a preferred type of food to cook on a particular day. When the mobile computing arrangement 400 approaches a media arrangement (e.g., billboard) that is promoting a food product, the keypad 414 is used to recall this preferred type of food stored for the corresponding calendar day. The request to the remote server corresponds to a request for receiving electronic coupon information including a menu and/or recipe involving that particular food or food type. Once received and stored in the program storage/memory 404, the electronic coupon information can be used later in the kitchen by the user of the mobile computing arrangement 400.

In accordance with yet another particular example implementation of the present invention, the mobile computing arrangement 400 prompts communication with a media arrangement (e.g., billboard) that is promoting a particular product or event. In this example implementation, the remote server is an electronic commerce arrangement that responds to the request by sending one or more electronic coupon information sets, each of which includes a group of questions, for example, as in an entertaining quiz or a profile regarding user demographics. The user responds by using the keypad 414 to select or enter answers to the questions. The answers are validated by the remote server and, in response to a threshold number of correct answers, the electronic commerce arrangement sends an electronic coupon providing a validate-able discount for the particular product or event. This electronic coupon is then stored in the program storage/memory 404 until validation.

The mobile computing arrangement 400 may also include a digital signal processor (DSP) 420. The DSP 420 may perform a variety of functions, including analog-to-digital (A/D) conversion, digital-to-analog (D/A) conversion, speech coding/decoding, encryption/decryption, error detection and correction, bit stream translation, filtering, etc. The transceiver 422, generally coupled to an antenna 424, transmits and receives the radio signals 426 between the wireless device and the network.

In connection with the present invention, the mobile computing arrangement 400 includes an RFID reader device 430, which includes a transceiver 432 and an antenna 434. The reader 430 transmits signals 436 which can be recognized by tags, thereby activating the tags. In response, the tags provide tag information signals 438, including the application identifier and content, which are provided to the reader application 406. The reader application determines which of the local applications 408 is to be invoked, based on the application identifier. The reader application 406 also provides the content to the appropriate application 408, once the appropriate application 408 has been identified. It should be recognized that the transceiver 422 used to establish wireless connections between the mobile device and the network can be used as the transceiver 432 associated with the RFID reader 430. However, because the transmissions performed with the network are high-frequency signals relative to the RF signals used in connection with the RFID reader 430, it may not be practical or possible to share the transceiver, although it is possible in some implementations.

The mobile computing arrangement 400 of FIG. 4 is provided as a representative example of a computing environment in which the principles of the present invention may be applied. From the description provided herein, those skilled in the art will appreciate that the present invention is equally applicable in a variety of other currently known and future mobile computing environments. For example, the software modules in accordance with the present invention may be stored in a variety of manners, may be operable on a variety of processing devices, and may be operable in mobile devices having additional, fewer, or different supporting circuitry and user-interface mechanisms.

Using the description provided herein, the invention may be implemented as a machine, process, or article of manufacture by using standard programming and/or engineering techniques to produce programming software, firmware, hardware or any combination thereof.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention. Any related code may be embodied on one or more computer-usable media such as resident memory devices, smart cards or other removable memory devices, or transmitting devices, thereby making a computer program product or article of manufacture according to the invention. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions using wireless/radio wave communication networks, the Internet, intranets, telephone/modem-based network communication, hard-wired/cabled communication network, satellite communication, and other stationary or mobile network systems/communication links.

The foregoing description of the exemplary embodiments of the invention has been presented for the purposes of illustration and description. It is not intended to be exhaustive or to limit the invention to the precise form disclosed. Many modifications and variations are possible in light of the above teaching. For example, it will be apparent to those skilled in the art from the foregoing description that the invention is equally applicable to other current or future radio frequency identification technologies using, for example, electromagnetic/electrostatic coupling, and thus the present invention is not limited to “RFID” technology as this term is currently used. It is intended that the scope of the invention be limited not with this detailed description, but rather defined by the claims appended hereto.

What is claimed is:

1. An interactive communications system for use in conveying service information to a user, the interactive communications system comprising:
a merchant-media arrangement having a merchant-media ID code and being adapted to communicate service initiation information including said merchant-media ID code to requesting devices over a short-range communication link;
a user-communications device being adapted to receive said service initiation information including at least the merchant-media ID code, and in response to receiving said service initiation information send a merchant-information-request signal that includes at least said merchant-media ID code; and
an electronic commerce arrangement adapted to generate, in response to receiving the merchant-information-request, service information data set that corresponds to the merchant-media ID code, and adapted to send the application data set to an address for access by the user.

2. The interactive communications system of claim 1, wherein the service information data set is sent in a downloadable Java Midlet to at least one of: the user-communications device and the merchant-media arrangement.

3. The interactive communications system of claim 2, wherein the user-communications device includes a user identification (ID) code and the merchant-information-request signal also includes data representative of the user identification ID code, and wherein the electronic commerce arrangement is further adapted to use the data representative of the user ID code for retrieving a user address to which the service information data set is sent.

4. The interactive communications system of claim 1, further including an electronic commerce redemption arrangement adapted to validate the service information data set, and wherein the merchant-media arrangement is located at a first location with information that corresponds to the service information data set, and wherein the redemption arrangement is located at a second location that is remote from the first location, the redemption arrangement being further adapted to redeem the service information data set in response to the service information data set being physically present at the second location.

5. The interactive communications system of claim 4, wherein the redemption arrangement is further adapted to redeem the service information data set by at least one of: changing the service information data set by altering or expanding the data in the set; and sending a coupon-void request for processing by the electronic commerce arrangement.

6. The interactive communications system of claim 1, wherein the merchant-media arrangement has a radio frequency identification (RFID) tag that transmits the merchant-media ID code via an RF signal, and wherein the user-communications device includes a RFID tag reader adapted to receive the RF signal and includes means for establishing a data link with, and sending the merchant-information-request signal to, the electronic commerce arrangement.

7. The interactive communications system of claim 6, wherein the RFID tag is adapted for transmitting in response to an activation signal.

8. The interactive communications system of claim 1, wherein the merchant-media arrangement includes means for receiving the user ID code from the user-communications device, and includes means for establishing a data link with, and sending the merchant-information-request signal to, the electronic commerce arrangement.

9. The interactive communications system of claim 1, wherein the user-communications device is a wireless-communications device, and wherein the merchant-media arrangement includes a transponder adapted to transmit the merchant-media ID code in response to a signal received from the wireless-communications device.

10. The interactive communications system of claim 9, wherein the wireless communications device includes a device selected from the group of: an identification card, travel card, a wireless telephone, a computer and a PDA.

11. The interactive communications system of claim 1, wherein the user-communications device is adapted to physically interface with the merchant-media arrangement.

12. The interactive communications system of claim 1, further including an electronic commerce redemption arrangement adapted to validate the service information data set, and wherein the merchant-media arrangement and the redemption arrangement are co-located for use by the user.

13. The interactive communications system of claim 1, wherein the electronic commerce arrangement is further adapted to generate a physical coupon article that includes a record of the service information data set.

14. The interactive communications system of claim 13, wherein the physical coupon article is selected from one of: a printed media; and an electronic data-storing device.

15. The interactive communications system of claim 1, wherein the electronic commerce arrangement is further adapted to send the service information data set in a downloadable Java Midlet to an external terminal for access by the user.

16. The interactive communications system of claim 1, wherein the user-communications device is a wireless telephone, and wherein the electronic commerce arrangement is further adapted to send the service information data set in a downloadable Java Midlet to the wireless telephone.

17. The interactive communications system of claim 1, wherein the service information data set includes at least one of the following: a non-discounted price for a merchant offering; a discounted price for a merchant offering; information for further interaction with the merchant-media arrangement; information for further interaction with the electronic commerce arrangement; a ticket for purchasing a merchant offering; and a ticket for receiving a free a merchant offering.

18. An interactive communications system for use in conveying service information to a user, the interactive communications system comprising:
a user-communications device including a user identification (ID) code stored therein; and
a merchant-media arrangement having a merchant-media ID code and being adapted to communicate with the user-communications device while the user-communications device is in proximity of the merchant-media arrangement, and in response, the user-communications device being adapted to send a merchant-information-request signal that includes at least the merchant-media ID code and the user identification (ID) data;
an electronic commerce arrangement adapted to generate, in response to receiving the merchant-information-request signal, an electronic coupon data set corresponding to the merchant-media ID code and user identification (ID) data and adapted to send the electronic coupon data set to an address determined using the merchant-information-request signal; and
a coupon-redemption arrangement adapted to redeem the electronic coupon data physical coupon article by processing the electronic coupon data set and, in response thereto, voiding any further use of the electronic coupon data set.

19. The interactive communications system of claim 18, wherein the coupon-generation arrangement is further adapted to send the electronic coupon data set in a downloadable Java Midlet to the user-communications device.

20. The interactive communications system of claim 18, wherein the coupon-generation arrangement is further adapted to send the electronic coupon data set in a downloadable Java Midlet to a terminal that generates a physical coupon article.

21. The interactive communications system of claim 20, wherein the physical coupon article is an electrically-alterable, data-storing user card.

22. The interactive communications system of claim 18, wherein the merchant-information-request signal includes the user ID code, and wherein the coupon-generation arrangement is further adapted to send the electronic coupon data to an address determined using the user ID code.

23. The interactive communications system of claim 18, wherein the user-communications device is adapted to send the merchant-information request signal to the coupon-generation arrangement via a wireless communications link.

24. The interactive communications system of claim 18, wherein the user-communications device is adapted to send the merchant-information request signal to the coupon-generation arrangement via a wired communications link.

25. The interactive communications system of claim 18, wherein the merchant-information-request signal includes the user ID code, and wherein the coupon-generation arrangement further includes a memory storing communications-user-receipt addresses, and the coupon-generation arrangement being adapted to access the memory and, using the data representative of the user ID code, to retrieve at least one communications-user-receipt address for the user, and to send the electronic coupon data set to the retrieved communications-user-receipt address.

26. The interactive communications system of claim 18, wherein the electronic coupon data set includes at least one of the following: a non-discounted price for a merchant offering; a discounted price for a merchant offering; information for further interaction with the merchant-media arrangement; information for further interaction with the electronic commerce arrangement; a ticket for purchasing a merchant offering; and a ticket for receiving a free a merchant offering.

27. For use with an interactive communications system having a merchant-media arrangement that conveys service information to users, a method of conveying information using a user-communications device, the method comprising:
in response to the user-communications device being in proximity of the merchant-media arrangement, generating a merchant-information-request signal that includes at least a merchant-media ID code for the merchant-media arrangement and sending the merchant-information-request signal to a remote server;
in response to receiving the merchant-information-request signal at the remote server, generating an electronic coupon data set that corresponds to the merchant-media ID code and sending the electronic coupon data set to an address for access by the user;
in response to the user receiving the electronic coupon data set, presenting the electronic coupon data set to a coupon-redemption arrangement; and
validating the electronic coupon data set at the coupon-redemption arrangement.

28. The method of claim 27, further including using the user-communications device to send the merchant-information-request signal to the remote server, and using the remote server to send the electronic coupon data set to the user-communications device.

29. An interactive communications system for use in conveying service information to a user, the interactive communications system comprising:
a user-communications device including a user identification (ID) code stored therein; and
a merchant-media arrangement having a merchant-media ID code and being adapted to communicate with the user-communications device while the user-communications device is in proximity of the merchant-media arrangement, the user-communications device and the merchant-media arrangement being adapted to send a merchant-information-request signal that includes at least the merchant-media ID code;
an electronic commerce arrangement adapted to generate, in response to receiving the merchant-information-request signal, a service information data set that corresponds to the merchant-media ID code, and adapted to send the service information data set to an address for access by the user; and
an electronic commerce redemption arrangement adapted to validate the service information data set.

30. The interactive communications system of claim 29, wherein the user-communications device includes an RFID tag, the merchant-media arrangement includes an RFID reader, and the merchant-media arrangement is adapted to send the merchant-information-request signal to the electronic commerce arrangement.

31. For use in an interactive communications system having merchant-communication terminals adapted to convey service information, a user-communications device comprising:
a first communication circuit adapted to communicate with a merchant-communication terminal over a short-range communication link, and adapted to receive service initiation information including at least a merchant-media ID code assigned to the merchant-communication terminal, and in response to receiving said service initiation information sending a merchant-information-request signal that includes at least said merchant-media ID code;
a second communication circuit adapted to receive an application data set from the interactive communications system, the application data set being sent in response to the merchant-information-request signal; and
a programmable processor circuit adapted to process the application data set and, in response thereto, to provide merchant-related information for the user.

32. The user-communications device of claim 31, wherein the programmable processor circuit includes a device display and the programmable processor circuit is further adapted to display the merchant-related information for the user.

33. The user-communications device of claim 31, wherein the merchant-related information is an electronic coupon, and wherein the programmable processor circuit is further adapted to receive validation data for validating the electronic coupon.

34. The user-communications device of claim 31, wherein the merchant-related information is an electronic coupon, and wherein the programmable processor circuit is further adapted to receive validation data for validating the electronic coupon and to receive redemption data for voiding the electronic coupon.
